(19) United States
(12) Patent Application Publication
(10) Pub. No.: US 2023/0064204 A1
(43) Pub. Date: Mar. 2, 2023

(54) METHODS FOR COORDINATING A MEDIA SESSION, RELATED NETWORK NODES, RELATED WIRELESS DEVICES, AND RELATED PRODUCTION DEVICES

(71) Applicant: Sony Group Corporation, Tokyo (JP)

(72) Inventors: Peter ISBERG, Lund (SE); Daniel LÖNNBLAD, Genarp (SE); Rickard LJUNG, Helsingborg (SE)

(21) Appl. No.: 17/793,902

(22) PCT Filed: Jan. 6, 2021
(86) PCT No.: PCT/EP2021/050114

§ 371 Date: Jul. 19, 2022

(30) Foreign Application Priority Data
Feb. 10, 2020 (SE) 2050139-1

(51) Int. Cl. H04N 21/61; H04N 21/6547

(52) U.S. Cl. CPC H04N 21/6131; H04N 21/6181; H04N 21/6547

(57) ABSTRACT

Disclosed is a method which may be performed by a network node. The media session may be configured to be associated with an event. The production device is configured to receive, from the one or more wireless devices, media data for the media session. The method comprises coordinating the event; and transmitting, to the one or more wireless devices, control signalling indicative of a coordination parameter for coordinating the event.

The present disclosure pertains to the field of wireless communications. The present disclosure relates to methods, related network nodes, related wireless devices, and related production devices.

### BACKGROUND

In a collaborative video streaming scenario over a wireless network, two or more wireless devices (such as user equipment, UEs, for example cameras) are configured to transfer media to a production device, such as a production server, via the wireless network. Further, in a scenario where the network or a function coupled to the network is capable of providing network assistance for collaborative video streaming, one or more of the wireless devices are able to communicate with one or more network nodes (for example one or more network assistance nodes) for network assistance signaling in addition to the media transfer.

The production device (such as a production server) and wireless devices can also interact with network assistance function.

However, challenges (such as misalignments) in the communication related to the network assistance signaling can occur, related to signaling of network assistance information to and/or from production device and wireless devices. Further, challenges related to media data (such as video quality adaptations) may arise, for example in case of multiple nodes receiving network assistance.

### SUMMARY

There is a need for coordination in network assistance related to a collaborative media session and management of information flow in order to provide that the different nodes are aligned in coordination parameter (such as a role parameter, a rate parameter, for example a rate control or a priority parameter, for example priority settings).

Further, there is a need for an improvement of network assistance, such as improving network assistance functionality and network assistance protocols. Although production devices and wireless devices (such as cameras) may communicate over separate communication links and exchange information outside of the network assistance (such as outside of the network assistance protocol) there is still a need for improvement of the network assistance and the communication between wireless devices and production devices. There may be a need for improving, such as reducing, the signalling overhead related to network assistance.

Accordingly, there is a need for production devices, wireless devices, network nodes and methods for controlling network assistance to a media session between one or more wireless devices and a production device, which mitigate, alleviate or address the existing shortcomings and provide coordination in network assistance so as to improve alignment between the various entities involved in a collaborative media session.

Disclosed is a method for coordinating a media session between one or more wireless devices and a production device. The method may be performed by a network node. The media session may be configured to be associated with an event. The media session may correspond to or may be associated with an event. The production device is configured to receive, from the one or more wireless devices, media data for the media session. The method comprises coordinating an event; and transmitting, to the one or more wireless devices, control signalling indicative of a coordination parameter for coordinating the event.

Further, a network node is provided, the network node comprising a memory circuitry, a processor circuitry, and a wireless interface. The network node is configured to perform any of the methods disclosed herein.

The disclosed network node and the disclosed method permit a coordination of the network assistance between the different entities (such as wireless device(s), production device) of the collaborative media session. For example, the disclosed method allows the various entities involved to be aware of each other's signalling, such as assigned role, which may lead to reducing unnecessary signalling.

Disclosed is a method for coordinating a media session between one or more wireless devices and a production device. The method may be performed by a production device. The media session may correspond to (and/or associated with) an event. The production device is configured to receive, from the one or more wireless devices, media data. The method comprises transmitting, to a network node, control signalling indicative of a coordination parameter.

Further, a production device is provided, the network node comprising a memory circuitry, a processor circuitry, and a wireless interface. The production device is configured to perform any of the methods disclosed herein.

The disclosed production device and the disclosed method allow benefiting from a role assignment allowing the various entities involved to declare their role regarding different functions, such as sending requests/queries to network assistance functionalities supporting the collaborative media session and/or controlling one or more types of network assistance functions for the media session.

Disclosed is a method for coordinating, using a network node, a media session between the wireless device and a production device. The method may be performed by a wireless device. The method comprises registering the wireless device to an event; and receiving, from the network node, control signalling indicative of a coordination parameter for coordinating the media session.

It is an advantage of the present disclosure that a coordination is achieved between the different entities (such as wireless device(s), production device, and/or network node) in a collaborative media session using network assistance. This ensures that the entities involved have an aligned behavior as result of the network assistance communication. The amount of signaling can also be reduced.

### BRIEF DESCRIPTION OF THE DRAWINGS

The above and other features and advantages of the present disclosure will become readily apparent to those skilled in the art by the following detailed description of example embodiments thereof with reference to the attached drawings, in which:

FIG. 1A is diagram illustrating an example wireless communication system,

FIG. 1B is diagram illustrating an example wireless communication system comprising an example network node, one or more example wireless devices, and an example production device according to this disclosure,

FIG. 2 is a flow-chart illustrating an example method for coordinating a media session between one or more wireless devices and a production device according to this disclosure,

FIG. 3 is a flow-chart illustrating an example method for coordinating a media session between one or more wireless devices and the production device according to this disclosure,

FIG. 4 is a flow-chart illustrating an example method for coordinating, using a network node, a media session between the wireless device and a production device according to this disclosure,

FIG. 5 is a block diagram illustrating an example network node according to this disclosure,

FIG. 6 is a block diagram illustrating an example production device according to this disclosure,

FIG. 7 is a block diagram illustrating an example wireless device according to this disclosure, and

FIGS. 8A-8D are signalling diagrams illustrating an example communication between an example wireless device, an example production device, and/or an example network node according to this disclosure.

### DETAILED DESCRIPTION

Various example embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

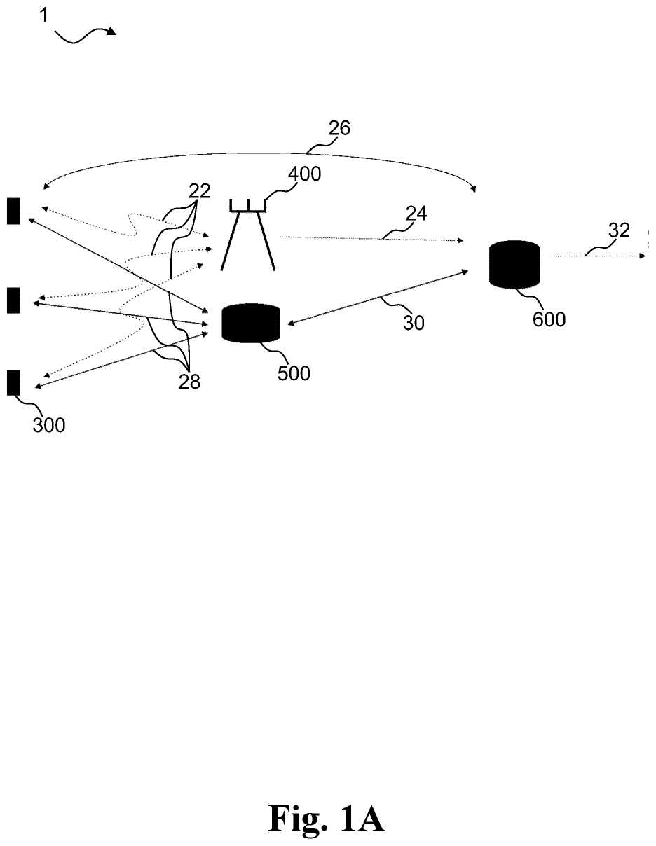

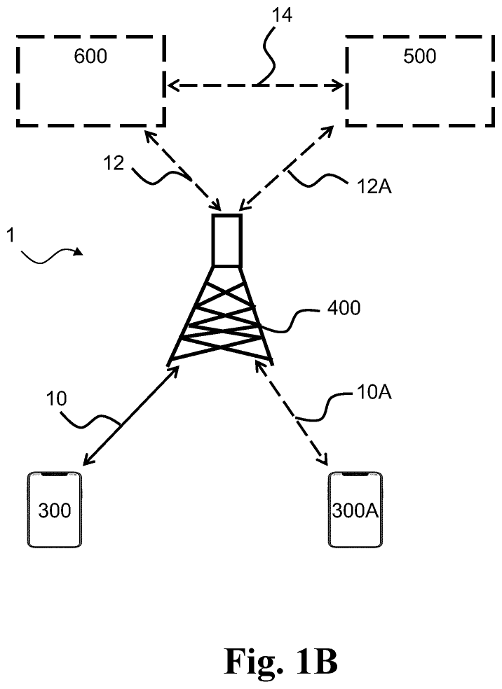

FIG. 1A is a diagram illustrating an example wireless communication system 1 comprising an example radio access network, RAN, node 400, one or more example wireless devices 300, an example network node 500 and an example production device 600.

In an example scenario illustrated in FIG. 1A one or more wireless devices 300 (such as one or more cameras) are producing media data (such as media content, for example video content). The one or more wireless devices 300 may connect to the wireless network and transmit 22 media data to the production device 600 via the RAN node 400. The media data is transmitted 22 (for example uploaded) via the RAN node 400 (such as over a wireless network), the RAN node is then transmitting 24 (such as sending) the media data to the production device 600. The one or more wireless devices 300 and the production device 600 may exchange signaling 26 (such as control signaling) with each other. The wireless network may have varying performance over time for the media data transmissions 22 (for example varying performance for each radio link between the one or more wireless devices and the RAN node). The variations in the media data transmissions 22 may occur for example due to variations in the radio propagation channel and the RAN node load (such as base station load). The media data from the one or more wireless devices 300 (such as the media content from the cameras) are received 24 at the production device 600. The production device 600 may for example be configured to manage a media session (such as a media data production, for example a video production) based on the media data (such as the camera content). The production device 600 may be configured to manage which of the one or more of the wireless devices 300 (for example cameras) are producing the media data (such as live video content) to be sent 32 from the production device 600 towards media data distribution (such as video distribution).

A network node 500 (such as a network assistance server, for example a network assistance function) is comprised in the wireless communication system 1 in order to communicate network assistance information with the one or more wireless devices 300 and the production device 600. The network assistance information may for example be related to the provision of a network assistance function (for example comprising priority information, such as camera priority information, for example being indicative of which camera is the live camera, for example being indicative of which camera(s) are expected to go live soon). It may be envisaged to have priorities between different events or sessions occurring in the same system. The network node 500 may be configured to provide control signaling 28, where the control signaling may comprise network assistance information (such as radio link information, for example of the links between the one or more wireless devices 300 and the production device 600 via the RAN node 400). The network node 500 may transmit 30 (such as send, such as forward) the control signaling 28 to the production device 600. The network node 500 and the production device 600 may exchange 30 control signaling with each other. The network assistance to the media session between the one or more wireless devices 300 and the production device 600 may comprise a network assistance protocol, such as to handle the communication between the one or more wireless devices 300 and the production device 600 via the RAN node 400.

The production device 600 and the one or more wireless devices 300 may have separate communication links to transmit and receive information or data which is not signaled over the network assistance protocols.

Although a production device and wireless devices may communicate over a separate communication link and exchange information outside of the network assistance protocol, it cannot be guaranteed that the network assistance functionality or protocol can work as expected to support the media session. There is a need for coordination in collaborative media session (such as video streaming) and management of information flow in order to provide that the different nodes/entities are aligned using the disclosed coordination parameter (such as a role parameter, a rate parameter, for example a rate control or a priority parameter, for example priority settings).

Further, there is a need for an improvement of network assistance, such as improving network assistance functionality and network assistance protocols.

FIG. 1B is a diagram illustrating an example wireless communication system 1 comprising an example radio access network, RAN, node 400, one or more example wireless devices 300, an example network node 500 and an example production device 600 according to this disclosure.

As discussed in detail herein, the present disclosure relates to a wireless communication system 1 comprising a cellular system, e.g. a 3^{rd} generation partnership project (3GPP) wireless communication system. The wireless communication system 1 comprises a wireless device 300 and/or a RAN node 400.

A RAN node disclosed herein refers to a radio access network node operating in the radio access network, such as a base station, an evolved Node B, eNB, gNB.

The wireless communication system 1 described herein may comprise a RAN including one or more wireless devices 300, 300A, and/or one or more RAN nodes 400, such as one or more of: a base station, an eNB, a gNB and/or an access point.

A wireless device may refer to a mobile device and/or a user equipment, UE. The wireless device 300 may comprise a optical sensing device (such as a camera device, for example broadcast cameras), and/or a sound sensing device (such as a microphone device), and/or a volumetric capturing device (such as a camera array or laser scanning device).

The wireless device 300, 300A may be configured to communicate with the RAN node 400 via a wireless link (or radio access link) 10, 10A.

The wireless device 300, 300A may be configured to communicate with the network node 500, via RAN node 400, and via wireless and/or wired link 12A between the network node 500 and the RAN node 400.

The wireless device 300, 300A may be configured to communicate with the production device 600, via RAN node 400, and via wireless and/or wired link 12 between the production device 600 and the RAN node 400.

The network node 500 may be configured to communicate with the production device 600, (optionally via RAN node 400), via wireless and/or wired link 14 between the production device 600 and the network node 500.

The production device 600 refers to a device (such as a server) configured to receive media data from a wireless device and to produce media content. The production device 600 may comprise one or more of: a media server, an application server, a production server, a media production unit, a media ingestion point, a content distributing device, a media sink device.

The network node 500 (such as a network assistance server, for example a network assistance function, NAF) is configured to perform network assistance services to a media session. The network assistance services for example comprise one or more of: priority information, such as camera priority information, for example being indicative of which camera is the live camera, rate control information, rate adaptation information, buffer-related information. The network node 500 is configured to control a network assistance to the media session between the one or more wireless devices 300 and the production device 600.

The network node 500 is configured to transmit control signaling (such as via the RAN node 400) indicative of a coordination parameter for coordinating the event, to the one or more wireless devices 300.

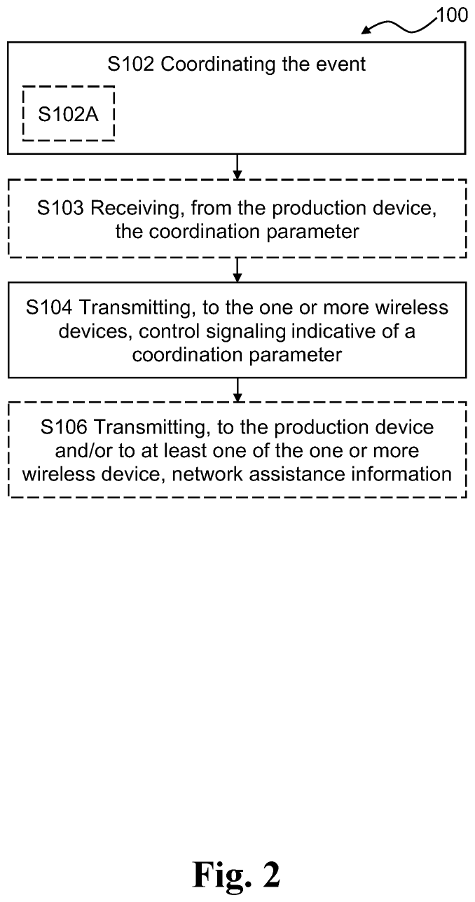

FIG. 2 shows a flow diagram of an example method 100 for coordinating a media session between one or more wireless devices and a production device according to the disclosure. For example, method 100 may be seen as a method for controlling network assistance to a media session between one or more wireless devices and a production device. The network assistance to the media session may be seen as supporting the media session with the network assistance information (such as priority information, coordination information, role information, rate information) so as to cope with conditions of the wireless and/or wired network. The wireless device may be configured to capture and transmit media data to the production device.

The method may be performed by a network node (such as the network node disclosed herein, such as network node 500 of FIGS. 1B, 5 and 8A-8D).

The media session may be configured to be associated with an event. The media session may correspond to or be associated with an event. It may be seen that the media session is within an event, such as associated with an event. The production device is configured to receive, from the one or more wireless devices, media data for the media session. A media session may be seen as a session for media data. The media data may comprise audio data and/or video data. For example the media data may comprise media data of one or more media types, such as descriptions of 3-dimensional objects (for example volumetric video). For example the media data may comprise computer-generated or output from volumetric capture of a real scene (for example one format being point clouds).

The method 100 comprises coordinating S102 the event. For example, the event corresponds to a media session. It may be seen that the media session is within an event, such as associated with an event. For example, coordinating S102 the event comprises coordinating the media session within an event. For example, coordinating S102 the event comprises coordinating the media session associated with an event. The event may lead to one or more media sessions generated by wireless device(s) and/or the production device. For example, coordinating S102 the event comprises coordinating the wireless devices and/or the production device within the event. For example, when wireless devices, such as cameras, are producing content to the production device, the media session carrying the content corresponds to (such as, is coupled to) an event. For example, before using network assistance, for example, for rate adaptation, it may be assumed that an event for this needs to be registered and/or setup at the network node (such as the network assistance node). For example, the registration may be conducted by the production device. The event may be time limited. The event information may be indicative of, for example, a number of wireless device to be connected (such as cameras to be connected) and their identities, priority of an event compared to other traffic in the system etc.

In one or more example, an event can correspond to a media event, such as a real-life event, such as a sporting event, a concert, a dramatic performance, and/or a news event, among others.

The method 100 comprises transmitting S104, to the one or more wireless devices, control signalling indicative of a coordination parameter for coordinating the event (such as coordinating the devices associated with the event). The coordination parameter may be seen as a parameter configured to support a coordination of the network assistance function to the media session, for example to control network assistance to a media session between one or more wireless devices and a production device. The coordination parameter may allow coordinating network assistance (for example priority and/or request/coordinate rate recommendation, and/or rejection of requests). In other words, the coordination parameter may be seen as a network assistance coordination parameter, for example a parameter for coordinating network assistance, for example a parameter for controlling network assistance to the media session. For example, for each network assistance information to be shared, the disclosed method allows coordination and assignment to be performed for an event by communicating the coordination parameter (which may allow a coordinator role to be clear between the entities involved in the event or media session).

For example, the coordination parameter comprises a role parameter. In one or more example embodiments, the role parameter is indicative of an assignment of a network assistance requester role to the production device or to at least one of the one or more wireless devices. For example, the wireless device and a production device may each have the possibility to ask a network assistance function about rate recommendations, which is part of the network assistance requester role. It may however, for network assistance pertaining to a specific wireless device, be desirable to ensure that only one of the devices (the wireless device and a production device) takes on the role during the media session. For example, there may be various roles defined, for example a “network assistance requester” role (for example a rate recommendation requester in other words), which may be assigned to one of the nodes (wireless device or production device) that is currently expected to send, for example, rate recommendation requests/queries to the network node acting as a network assistance function.

For example, in a scenario where there are five wireless devices (such as five cameras), it may be envisaged that four of wireless devices have the network assistance requester role while for the fifth wireless device, the production device has the network assistance requester role (for example, the fifth wireless device may be a legacy camera which can communicate with the production device but does not have the ability to communicate to the network node, NAF).

In one or more example methods, the coordination parameter comprises a time parameter indicating a time period where the network node temporarily rejects a network assistance request from the one or more wireless devices. The time period may be a time period where the network node transmits to the wireless device a negative response (for example by using non-acknowledgement NACK message) to the network assistance request. The time period may be a time period where the network node blocks the wireless device for network assistance. For example, the network node (such as network assistance node) can use a rejection (such as a blocking/negative response) in scenarios when the network node considers the event or media session to be uncoordinated. For example, the network node may temporarily block additional requests or queries from other wireless devices in case a first wireless device has sent a request or query related to a specific wireless device. For example, the temporary blocking can use a timer and a defined timer value per wireless device, to start the timer upon a request/query for a wireless device and not respond with any rate recommendations or similar for this wireless device to any other wireless device until the timer has expired. For example, a production device sends a request/query about a wireless device (such as camera “X”), the network node, such as the network assistance function, may be configured to respond with a block/negative acknowledgement to avoid having the wireless device send a request/query within the timer value.

In one or more example embodiments, the network node may not allow any additional queries from other wireless devices until a new event and/or a new media session is created. For example, the timer value may be infinite.

In one or more example methods, the coordination parameter comprises a network assistance type indication. For example, the coordination may be performed in accordance to a type of network assistance. For example, the role parameter is indicative of an assignment of a network assistance requester role for a network assistance type, such as for priority indication assistance (e.g. using a network assistance type indication indicative of priority). For example, the type of network assistance may comprise rate recommendation related assistance information and/or priority indication assistance signalling. In one or more embodiments, the role parameter may comprise a parameter indicative of a role of transmitting rate recommendation related assistance information. In one or more embodiments, the role parameter may comprise a parameter indicative of priority indication assistance signalling. For example, it may be envisaged that an event only has a role for priority indication, but no other role for any other assistance signalling. For example, it may be envisaged that an event only has a role for rate recommendation, but no other role for any other assistance signalling.

In one or more example methods, the method 100 comprises transmitting S106, to the production device and/or to at least one of the one or more wireless devices, network assistance information in response to the transmission S104 of the control signalling indicative of the coordination parameter. In one or more embodiments, the network assistance information may be transmitted to all devices associated with the event: the one or more wireless devices, and the production device. In one or more embodiments, the network assistance information may be transmitted to the production device. In one or more embodiments, the network assistance information may be transmitted to all the wireless devices associated with the event. For example, the network assistance information primarily pertains to one specific wireless device. In other words, the network assistance information may be transmitted in response to a role assignment signalled by the coordination parameter. For example, the network node, such as the network assistance node, may be configured to distribute network assistance information, for example rate recommendation information to more nodes than to the device that transmitted the network assistance request. For example, the network assistance function may allow transmission of network assistance information (for example rate recommendation information) both to the node that sent the network assistance request (e.g. a UE) but also to the production device. For example, when the network assistance request was transmitted from the production device, also the individual UE may receive the network assistance information (such as rate recommendation) as well.

In one or more example methods, the network assistance information comprises a rate parameter, and/or a device priority parameter, and/or a buffer parameter and/or a quality report parameter. For example the rate parameter may comprise a recommended rate parameter, and/or a rate category parameter. For example, the buffer parameter may comprise buffer level parameter, and/or buffer boosting parameter.

In one or more example methods, coordinating S102 the event comprises receiving S102A, from the production device, a registration request for registering the event. In one or more example methods, the registration request is indicative of one or more wireless devices associated with the event. In one or more example methods, the registration request comprises the role parameter, or optionally, a coordination parameter that may include a role parameter.

In one or more example methods, the method 100 comprises receiving S103, from the production device, the coordination parameter. Optionally, the coordination parameter comprises the role parameter. In one or more example methods, when the coordination parameter is received from the production device, the network node may be configured to transmit the coordination parameter to the one or more wireless devices.

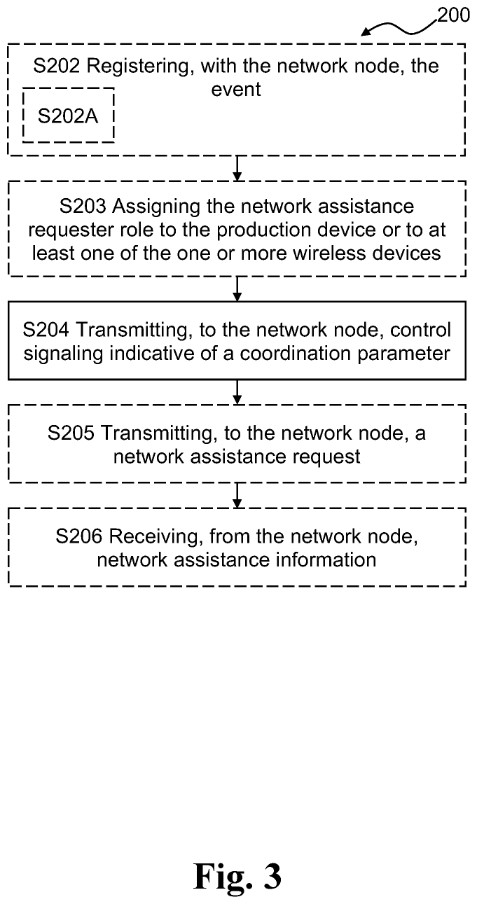

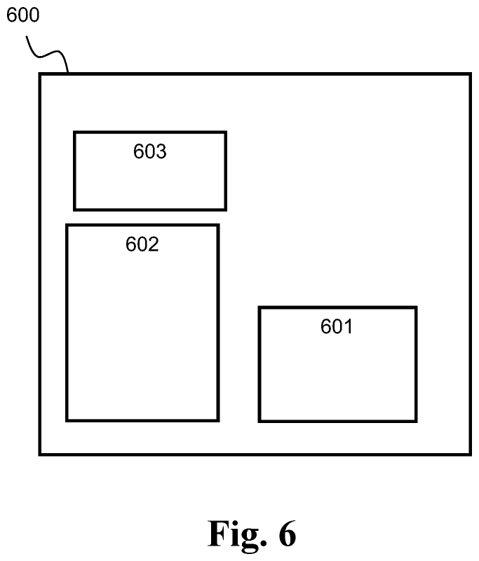

FIG. 3 shows a flow diagram of an example method 200 for coordinating a media session within an event between one or more wireless devices and a production device according to the disclosure. Optionally, the method 200 is performed at a production device (such as the production device disclosed herein, such as the production device 600 of FIG. 1B and FIGS. 6, 8A-8C).

The method 200 comprises transmitting S204, to a network node, control signalling indicative of a coordination parameter. In one or more example methods, the coordination parameter comprises a role parameter. In one or more example methods the role parameter is indicative of an assignment of a network assistance requester role to the production device or to at least one of the one or more wireless devices. In one or more example methods, the coordination parameter comprises a time parameter indicating a time period where the network node temporarily rejects a network assistance request from the one or more wireless devices. Optionally, the time parameter is transmitted from the production device, for example to be adopted in the network node. Optionally, the time parameter is a parameter set directly in the network node (such as network node function).

In one or more example methods, the method 200 comprises assigning S203 the network assistance requester role to the production device.

In one or more example methods, the method 200 comprises assigning S203 the network assistance requester role to at least one of the one or more wireless devices.

In one or more example methods, the method 200 comprises transmitting S205, to the network node, a network assistance request. In one or more example methods, the method 200 comprises receiving S206, from the network node, network assistance information.

In one or more example methods, the method 200 comprises registering S202, with the network node, the event.

In one or more example methods, registering S202 the event comprises transmitting S202A, to the network node, a registration request for registering the event. In one or more example methods, the registration request is indicative of one or more wireless devices associated with the event.

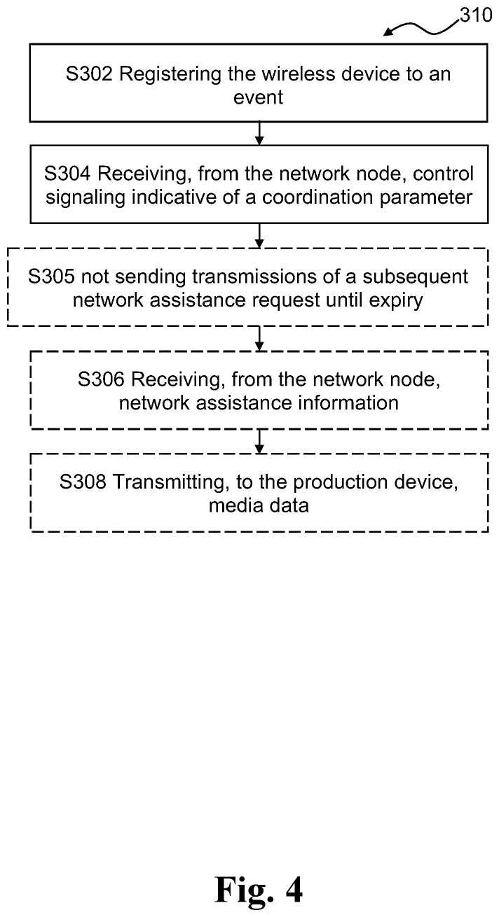

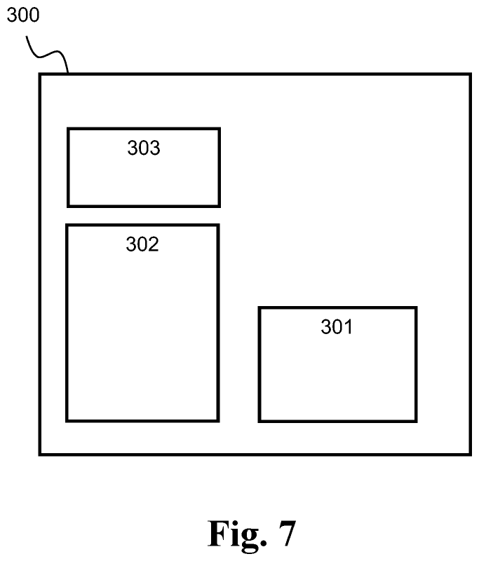

FIG. 4 shows a flow diagram of an example method 310 for coordinating, using a network node, a media session between the wireless device and a production device according to the disclosure. Optionally, the method 310 is performed by a wireless device (such as the wireless device disclosed herein, such as the wireless device 300 of FIG. 1B and FIGS. 7, 8A-8D).

The method 310 comprises registering S302 the wireless device to an event. The method 310 comprises receiving S304, from the network node, control signalling indicative of a coordination parameter for coordinating the media session. In one or more example methods, the coordination parameter comprises a role parameter.

In one or more example methods, the role parameter is indicative of an assignment of a network assistance requester role to the production device or to the wireless device.

In one or more example methods, the coordination parameter comprises a time parameter indicating a time period where the network node temporarily rejects a network assistance request from the wireless device. The time period may be a time period where the network node transmits to the wireless device a negative response (for example by using non-acknowledgement NACK message) to the network assistance request. The time period may be a time period where the network node blocks the wireless device for network assistance.

In one or more example methods, when the coordination parameter comprises the time parameter, the method 310 comprises not sending S305 transmissions of a subsequent network assistance request until expiry of the time period. In other words, not sending transmissions of a subsequent network assistance request until expiry of the time period, may comprise refraining from transmitting the subsequent network assistance request.

In one or more example methods, the method 310 comprises receiving S306, from the network node, network assistance information, such as in response to receiving S304, from the network node, the control signalling indicative of the coordination parameter for coordinating the media session.

In one or more example methods, the method 310 comprises transmitting S308, to the production device, media data, in accordance with the network assistance information.

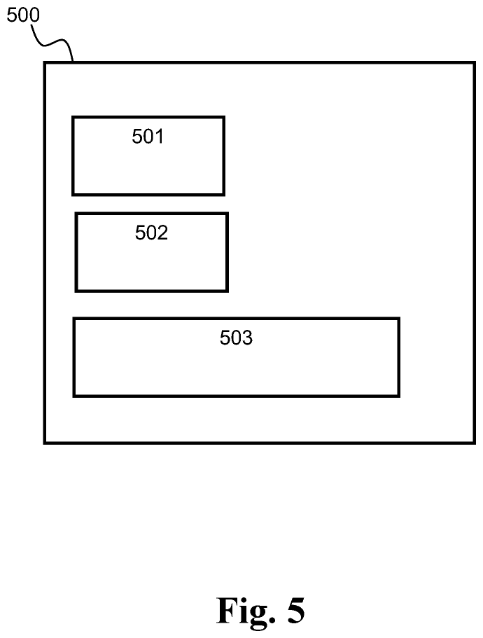

FIG. 5 shows a block diagram of an example network node 500 according to the disclosure. The network node 500 comprises a memory circuitry 501, a processor circuitry 502, and a wireless interface 503. The network node 500 may be configured to perform any of the methods disclosed in FIG. 2. In other words, the network node 500 may be configured for controlling network assistance to a media session between one or more wireless devices and a production device. The media session may correspond to (and/or associated with) an event. The production device is configured to receive, from the one or more wireless devices, media data for the media session.

The network node 500 is configured to communicate with a wireless device, such as the wireless device disclosed herein, and with a production device, such as the wireless device disclosed herein, using a wireless communication system.

The wireless interface 503 is configured for wireless communications via a wireless communication system, such as a 3GPP system, such as a 3GPP system supporting network assistance.

The network node 500 is configured to coordinate (such as via the wireless interface 503 and/or the processor circuitry 502) the event.

The network node 500 is configured to transmit (such as via the wireless interface 503), to the one or more wireless devices, control signalling indicative of a coordination parameter for coordinating the event.

In one or more example network nodes, the coordination parameter comprises a role parameter. In one or more example network nodes, the role parameter is indicative of an assignment of a network assistance requester role to the production device or to at least one of the one or more wireless devices.

In one or more example network nodes, the coordination parameter comprises a time parameter indicating a time period where the network node temporarily rejects a network assistance request from the one or more wireless devices.

In one or more example network nodes, the coordination parameter comprises a network assistance type indication.

In one or more example network nodes, the network node 500 is configured to transmit (such as via the wireless interface 503), to the production device and/or to at least one of the one or more wireless devices, network assistance information in response to the transmission of the control signalling indicative of the coordination parameter.

In one or more example network nodes, the network assistance information comprises a rate parameter, and/or a device priority parameter, and/or a buffer parameter and/or a quality report parameter.

In one or more example network nodes, the network node 500 is configured to receive (such as via the wireless interface 503), from the production device, the coordination parameter.

In one or more example network nodes, the network node 500 is configured to coordinate the event by receiving, from the production device, a registration request for registering the event. The registration request being indicative of one or more wireless devices associated with the event.

In one or more example network nodes, the registration request comprises the role parameter.

The processor circuitry 502 is optionally configured to perform any of the operations disclosed in FIG. 2 (such as any one or more of S102A, S103, S106). The operations of the network node 500 may be embodied in the form of executable logic routines (e.g., lines of code, software programs, etc.) that are stored on a non-transitory computer readable medium (e.g., the memory circuitry 501) and are executed by the processor circuitry 502).

Furthermore, the operations of the network node 500 may be considered a method that the network node 500 is configured to carry out. Also, while the described functions and operations may be implemented in software, such functionality may as well be carried out via dedicated hardware or firmware, or some combination of hardware, firmware and/or software.

The memory circuitry 501 may be one or more of a buffer, a flash memory, a hard drive, a removable media, a volatile memory, a non-volatile memory, a random access memory (RAM), or other suitable device. In a typical arrangement, the memory circuitry 501 may include a non-volatile memory for long term data storage and a volatile memory that functions as system memory for the processor circuitry 502. The memory circuitry 501 may exchange data with the processor circuitry 502 over a data bus. Control lines and an address bus between the memory circuitry 501 and the processor circuitry 502 also may be present (not shown in FIG. 5). The memory circuitry 501 is considered a non-transitory computer readable medium.

The memory circuitry 501 may be configured to store the coordination parameter in a part of the memory.

FIG. 6 shows a block diagram of an example production device 600 according to the disclosure. The production device 600 comprises a memory circuitry 601, a processor circuitry 602, and a wireless interface 603. The production device 600 is configured to perform any of the methods disclosed in FIG. 3. In other words, the production device 600 is configured for coordinating a media session corresponding to an event between one or more wireless devices 300 and the production device 600.

The production device 600 is configured to receive, from the one or more wireless devices, media data.

The production device 600 is configured to communicate with a wireless device, such as the wireless device disclosed herein, using a wireless communication system.

The wireless interface 603 is configured for wireless communications via a wireless communication system, such as a 3GPP system, such as a 3GPP system supporting network assistance.

The production device 600 is configured to transmit (such as via the wireless interface 603), to the network node, control signalling indicative of a coordination parameter. In one or more example production devices, the coordination parameter comprises a role parameter. In one or more example production devices, the role parameter is indicative of an assignment of a network assistance requester role to the production device or to at least one of the one or more wireless devices.

In one or more example production devices, the coordination parameter comprises a time parameter indicating a time period where the network node temporarily rejects a network assistance request from the one or more wireless devices. Optionally, the time parameter is transmitted from the production device, for example to be adopted in the network node. Optionally, the time parameter is a parameter set directly in the production device.

In one or more example production devices, the production device 600 is configured to assign (for example using the processor circuitry 602) the network assistance requester role to the production device.

In one or more example production devices, the production device 600 is configured to assign (for example using the processor circuitry 602) the network assistance requester role to at least one of the one or more wireless devices.

In one or more example production devices, the production device 600 is configured to transmit (such as via the wireless interface 603), to the network node, a network assistance request.

In one or more example production devices, the production device 600 is configured to receive (such as via the wireless interface 603), from the network node, network assistance information.

In one or more example production devices, the production device 600 is configured to register (such as via the wireless interface 603 and/or the processor circuitry 602), with the network node, the event.

In one or more example production devices, the production device 600 is configured to transmit (such as via the wireless interface 603), to the network node, a registration request for registering the event. In one or more example production devices, the registration request is indicative of one or more wireless devices associated with the event.

The processor circuitry 602 is optionally configured to perform any of the operations disclosed in FIG. 3 (such as any one or more of S202, S202A, S203, S205, S206). The operations of the production device 600 may be embodied in the form of executable logic routines (e.g., lines of code, software programs, etc.) that are stored on a non-transitory computer readable medium (e.g., the memory circuitry 601) and are executed by the processor circuitry 602).

Furthermore, the operations of the production device 600 may be considered a method that the production device 600 is configured to carry out. Also, while the described functions and operations may be implemented in software, such functionality may as well be carried out via dedicated hardware or firmware, or some combination of hardware, firmware and/or software.

The memory circuitry 601 may be one or more of a buffer, a flash memory, a hard drive, a removable media, a volatile memory, a non-volatile memory, a random access memory (RAM), or other suitable device. In a typical arrangement, the memory circuitry 601 may include a non-volatile memory for long term data storage and a volatile memory that functions as system memory for the processor circuitry 602. The memory circuitry 601 may exchange data with the processor circuitry 602 over a data bus. Control lines and an address bus between the memory circuitry 601 and the processor circuitry 602 also may be present (not shown in FIG. 6). The memory circuitry 601 is considered a non-transitory computer readable medium.

The memory circuitry 601 may be configured to store the coordination parameter in a part of the memory.

FIG. 7 shows a block diagram of an example wireless device 300 according to the disclosure. The wireless device 300 comprises a memory circuitry 301, a processor circuitry 302, and a wireless interface 302. The wireless device 300 is configured to perform any of the methods disclosed in FIG. 4. In other words, the wireless device 300 is configured for coordinating, using a network node, a media session between the wireless device 300 and a production device 600.

The wireless device 300 is configured to communicate with a production device 600, such as the production device disclosed herein, using a wireless communication system.

The wireless interface 303 is configured for wireless communications via a wireless communication system, such as a 3GPP system, such as a 3GPP system supporting network assistance.

The wireless device 300 is configured to register (such as via the wireless interface 303 and/or the processor circuitry 302) the wireless device to an event. For example, the event is coordinated between the wireless device, the network node and the production device.

The wireless device 300 is configured to receive (such as via the wireless interface 303), from the network node, control signalling indicative of a coordination parameter for coordinating the media session. In one or more example wireless devices, the coordination parameter comprises a role parameter.

In one or more example wireless devices, the role parameter is indicative of an assignment of a network assistance requester role to the production device or to the wireless device.

In one or more example wireless devices, the coordination parameter comprises a time parameter indicating a time period where the network node temporarily rejects a network assistance request from the wireless device.

In one or more example wireless devices, when the coordination parameter comprises the time parameter, the wireless device 300 is configured to not send transmissions (such as using the processor circuitry 302 and/or the wireless interface 303) of a subsequent network assistance request until expiry of the time period.

In one or more example wireless devices, the wireless device 300 may be configured to receive (such as via the wireless interface 303), from the network node, network assistance information in response to the reception, from the network node, of the control signalling indicative of the coordination parameter for coordinating the media session.

In one or more example wireless devices, the wireless device 300 may be configured to transmit (such as via the wireless interface 303), to the production device, media data, in accordance with the network assistance information.

The processor circuitry 302 is optionally configured to perform any of the operations disclosed in FIG. 4 (such as any one or more of S305, S306, S308). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302.

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 7). The memory circuitry 301 is considered a non-transitory computer readable medium.

The memory circuitry 301 may be configured to store the coordination parameter in a part of the memory.

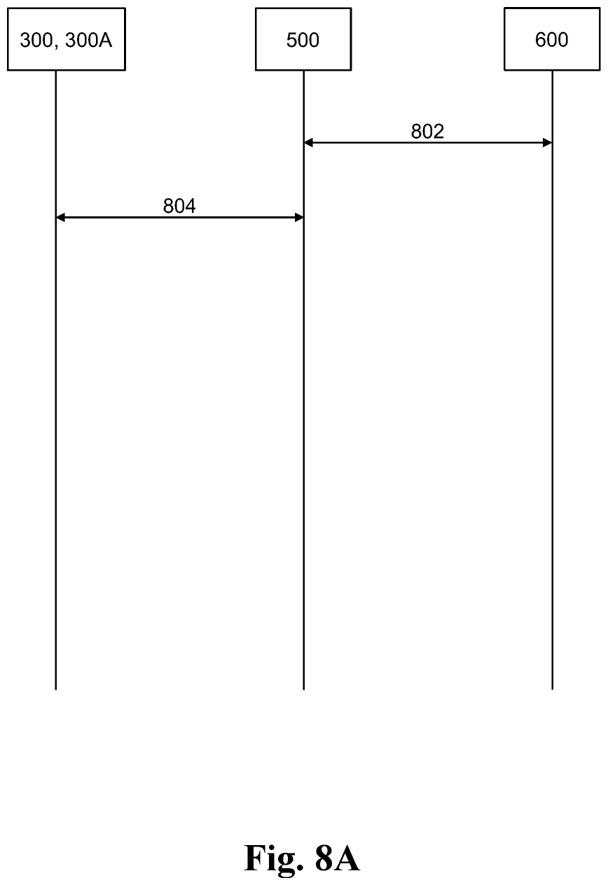

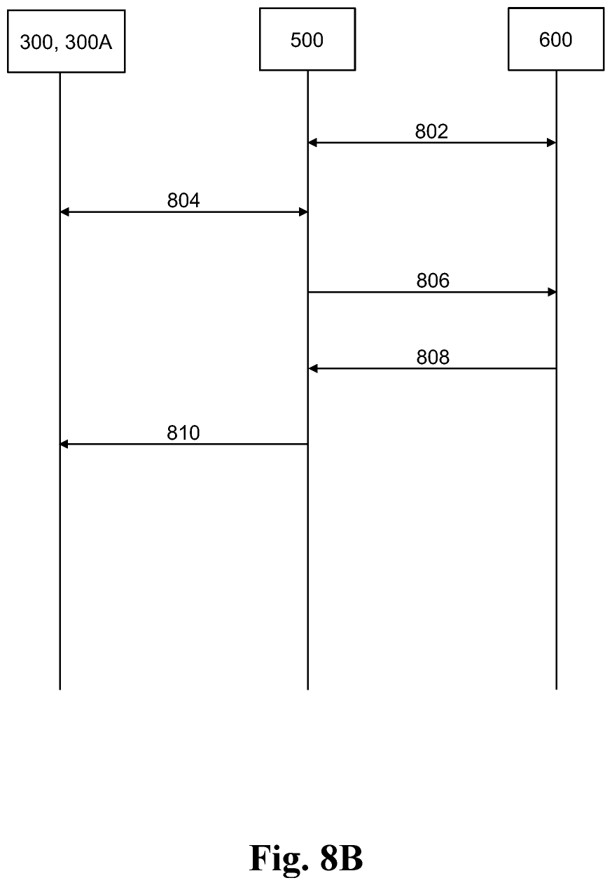

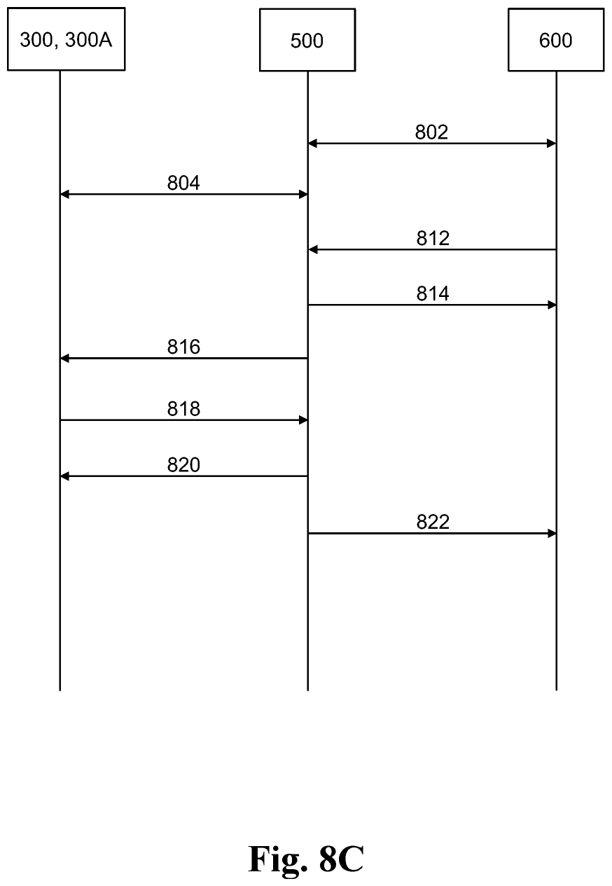

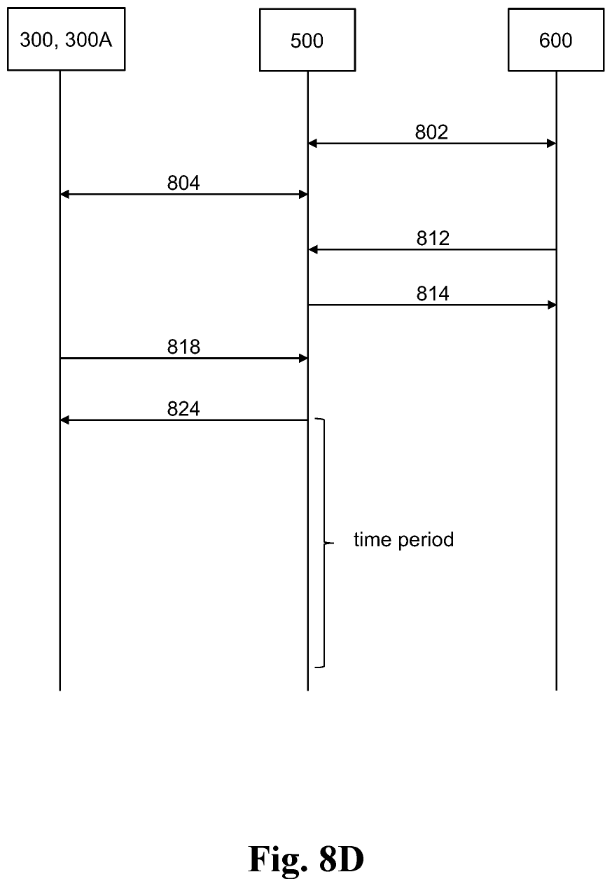

FIGS. 8A-8D are signalling diagrams illustrating an example communication between an example wireless device 300, 300A, an example production device 600, and/or an example network node 500 according to this disclosure. Although the signalling diagrams of FIGS. 8A-8D may appear as showing one example wireless device, the signalling diagram is applicable to a scenario with a plurality of wireless devices 300, 300A. It may be envisaged that the media session is coordinated between a plurality of wireless devices 300, 300A and a production device 600, via a network node 500.

In FIG. 8A, the network node 500 acting as a network assistance function performs an event registration with the production device 600, by exchanging one or more messages 802 indicative of event registration (such as a registration request). The one or more messages 802 comprises a coordination parameter disclosed herein, such as a role parameter disclosed herein. For example, the role parameter indicates that the network assistance requester role is assigned to the production device 600 or to the wireless device 300, 300A.

The wireless device 300, 300A performs a wireless device registration (such as a camera registration) with the network node 500, by exchanging one or more messages 804 indicative of registration. The one or more messages 804 may comprise a coordination parameter disclosed herein, such as a role parameter disclosed herein. For example, the role parameter may indicate that the network assistance requester role is assigned to the production device 600 or to the wireless device 300, 300A.

In FIG. 8B, the network node 500 acting as a network assistance function performs an event registration with the production device 600, by exchanging one or more messages 802 indicative of event registration (such as a registration request).

The wireless device 300, 300A performs a wireless device registration (such as a camera registration) with the network node 500, by exchanging one or more messages 804 indicative of registration.

The network node 500 sends message 806 to the production device 600. The message 806 indicates the wireless device registration information. For example, the wireless device registration information comprises one or more of: a wireless device identifier (e.g. UE identity), brand information, type information and capabilities (such as, in terms of one or more of: resolution, frame rate, codec support, bit rate range).

The network node 500 receives message 808 from the production device 600. The message 808 comprises a coordination parameter disclosed herein, such as a role parameter disclosed herein. For example, the role parameter indicates that the network assistance requester role is assigned to the production device 600 or to the wireless device 300.

The network node 500 sends message 810 to the wireless device 300, 300A. The message 810 comprises the coordination parameter disclosed herein, such as the role parameter disclosed herein, possibly assigned by the production device 600. For example, the role parameter indicates that the network assistance requester role is assigned to the production device 600 or to the wireless device 300, 300A.

It may be envisaged that the production device 600 defines the role of each node/entity (for example of the wireless device and of the production device) in the production event. For example, the production device 600 defines for multiple wireless devices (such as cameras or microphones) that are expected to be registered to an event by the production device 600. When determining an event (such as setting up a new video streaming event), the production device may define the role of the wireless devices.

Optionally, the production device 600 can be notified by the network node 500 acting as a network assistance function each time a new wireless device registers to the event. The production device can respond with a coordination parameter (such as a role parameter, for example information on the role the camera shall take in the event).

In the present disclosure, each entity associated with the event can know which role it is assigned to, and the production device can ensure that the system is coordinated.

In FIG. 80, the network node 500 acting as a network assistance function performs an event registration with the production device 600, by exchanging one or more messages 802 indicative of event registration (such as a registration request).

The wireless device 300, 300A performs a wireless device registration (such as a camera registration) with the network node 500, by exchanging one or more messages 804 indicative of registration.

The network node 500 receives message 812 from the production device 600. The message 812 is a network assistance request (such as for rate recommendation for the wireless device).

The network node 500 sends message 814 to the production device 600. The message 814 comprises a network assistance information.

The network node 500 sends message 816 to the wireless device 300, 300A. The message 816 comprises a network assistance information. In other words, the network node 500 distributes the network assistance information to the wireless device 300, 300A.

The wireless device 300 sends message 818 to the network node 500. The message 818 is a network assistance request (such as for rate recommendation for the wireless device).

The network node 500 sends message 820 to the wireless device 300. The message 820 comprises a network assistance information regarding rate recommendation. The network node 500 sends message 822 to the production device 600. The message 822 comprises the network assistance information regarding the rate recommendation.

For example, the network node, such as the network assistance node, may be configured to distribute network assistance information, for example rate recommendation information to more nodes than to the device that transmitted the network assistance request. For example, the network assistance function may allow transmission of network assistance information (for example rate recommendation information) both to the node that sent the network assistance request (e.g. a UE) but also to the production device. For example, when the network assistance request was transmitted from the production device, also the individual UE may receive the network assistance information (such as rate recommendation) as well.

In FIG. 8D, the network node 500 acting as a network assistance function performs an event registration with the production device 600, by exchanging one or more messages 802 indicative of event registration (such as a registration request).

The wireless device 300, 300A performs a wireless device registration (such as a camera registration) with the network node 500, by exchanging one or more messages 804 indicative of registration.

The network node 500 receives message 812 from the production device 600. The message 812 is a network assistance request (such as for rate recommendation for the wireless device). The network node 500 sends message 814 to the production device 600. The message 814 comprises a network assistance information regarding rate recommendation.

The wireless device 300 sends message 818 to the network node 500. The message 818 is a network assistance request (such as for rate recommendation for the wireless device).

The network node 500 sends message 824 to the wireless device 300. The message 824 comprises control signalling indicative of a coordination parameter comprising a time parameter indicating a time period where the network node temporarily rejects a network assistance request from the wireless device. For example, message 824 comprises a negative response, such as NACK message (instead of a rate recommendation for example).

For example, the network node may temporarily block additional requests or queries from other wireless devices in case a first wireless device has sent a request or query related to a specific wireless device. For example, the temporary blocking can use a timer and a defined timer value per wireless device, to start the timer upon a request/query for a wireless device and not respond with any rate recommendations or similar for this wireless device to any other wireless device until the timer has expired. For example, a production device sends a request/query about a wireless device (such as camera “X”), the network node, such as the network assistance function, may be configured to respond with a block/negative acknowledgement to avoid having the wireless device send a request/query within the timer value.

In one or more example embodiments, the network node may not allow any additional queries from other wireless devices until a new event is created. For example, the timer value may be infinite.

Embodiments of methods and products (network nodes, production devices and wireless device) according to the disclosure are set out in the following items:

Item 1. A method for coordinating a media session between one or more wireless devices and a production device, wherein the media session is configured to be associated with an event, wherein the production device is configured to receive, from the one or more wireless devices, media data for the media session, the method comprising:
coordinating (S102) the event; and
transmitting (S104), to the one or more wireless devices, control signalling indicative of a coordination parameter for coordinating the event.

Item 2. The method according to item 1 wherein the coordination parameter comprises a role parameter.

Item 3. The method according to item 2, wherein the role parameter is indicative of an assignment of a network assistance requester role to the production device or to at least one of the one or more wireless devices.

Item 4. The method according to any of the previous items, wherein the coordination parameter comprises a time parameter indicating a time period where the network node temporarily rejects a network assistance request from the one or more wireless devices.

Item 5. The method according to any of the previous items wherein the coordination parameter comprises a network assistance type indication.

Item 6. The method according to any of the previous items, the method comprising transmitting (S106), to the production device and/or to at least one of the one or more wireless devices, network assistance information in response to the transmission (S104) of the control signalling indicative of the coordination parameter.

Item 7. The method according to item 6, wherein the network assistance information comprises a rate parameter, and/or a device priority parameter, and/or a buffer parameter and/or a quality report parameter.

Item 8. The method according to any of items 1-7, the method comprising receiving (S103), from the production device, the coordination parameter.

Item 9. The method according to any of the previous items, wherein coordinating (S102) the event comprises:
receiving (S102A), from the production device, a registration request for registering the event, wherein the registration request is indicative of one or more wireless devices associated with the event.

Item 10. The method according to item 9 as dependent on item 2, wherein the registration request comprises the role parameter.

Item 11. A method for coordinating a media session between one or more wireless devices and a production device, wherein the production device is configured to receive, from the one or more wireless devices, media data, the method comprising:
transmitting (S204), to a network node, control signalling indicative of a coordination parameter.

Item 12. The method according to item 11, the method comprising: assigning (S203) the network assistance requester role to the production device or to at least one of the one or more wireless devices.

Item 13. The method according to any of items 11-12, wherein the coordination parameter comprises a role parameter, wherein the role parameter is indicative of an assignment of a network assistance requester role to the production device or to at least one of the one or more wireless devices.

Item 14. The method according to any of items 11-13, wherein the coordination parameter comprises a time parameter indicating a time period where the network node temporarily rejects a network assistance request from the one or more wireless devices.

Item 15. The method according to any of items 11-14, the method comprising:
transmitting (S205), to the network node, a network assistance request; and
receiving (S206), from the network node, network assistance information.

Item 16. The method according to any of items 11-15, the method comprising registering (S202), with the network node, the event.

Item 17. The method according to any of items 11-16, wherein registering (S202) the event comprises:
transmitting (S202A), to the network node, a registration request for registering the event, wherein the registration request is indicative of one or more wireless devices associated with the event.

Item 18. A method for coordinating, using a network node, a media session between the wireless device and a production device, the method comprising:
registering (S302) the wireless device to an event; and
receiving (S304), from the network node, control signalling indicative of a coordination parameter for coordinating the media session.

Item 19. The method according to item 18, wherein the coordination parameter comprises a role parameter.

Item 20. The method according to item 19, wherein the role parameter is indicative of an assignment of a network assistance requester role to the production device or to the wireless device.

Item 21. The method according to any of items 18-20, wherein the coordination parameter comprises a time parameter indicating a time period where the network node temporarily rejects a network assistance request from the wireless device.

Item 22. The method according to item 21, wherein when the coordination parameter comprises the time parameter, the method comprises: not sending (S305) transmissions of a subsequent network assistance request until expiry of the time period.

Item 23. The method according to any of items 18-22, the method comprising receiving (S306), from the network node, network assistance information.

Item 24. The method according to any of items 18-23, the method comprising transmitting (S308), to the production device, media data, in accordance with the network assistance information.

Item 25. A network node comprising a memory circuitry, a processor circuitry, and a wireless interface, wherein the network node is configured to perform any of the methods according to any of items 1-10.

Item 26. A production device comprising a memory circuitry, a processor circuitry, and a wireless interface, wherein the production device is configured to perform any of the methods according to any of items 11-17.

Item 27. A wireless device comprising a memory circuitry, a processor circuitry, and a wireless interface, wherein the wireless device is configured to perform any of the methods according to any of items 18-24.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-8D comprise some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method for coordinating a media session between one or more wireless devices and a production device, wherein the media session is configured to be associated with an event, wherein the production device is configured to receive, from the one or more wireless devices, media data for the media session, the method
comprising:
coordinating the event; and
transmitting, to the one or more wireless devices, control signaling indicative of a coordination parameter for coordinating the event, wherein the coordination parameter comprises a role parameter.

2. The method according to claim 1, wherein the role parameter is indicative of an assignment of a network assistance requester role to the production device or to at least one of the one or more wireless devices.

3. The method according to claim 1, wherein the coordination parameter comprises a time parameter indicating a time period where the network node temporarily rejects a network assistance request from the one or more wireless devices.

4. The method according to claim 1, wherein the coordination parameter comprises a network assistance type indication.

5. The method according to claim 1, the method comprising transmitting, to the production device and/or to at least one of the one or more wireless devices, network assistance information in response to the transmission of the control signalling indicative of the coordination parameter.

6. The method according to claim 5, wherein the network assistance information comprises a rate parameter, and/or a device priority parameter, and/or a buffer parameter and/or a quality report parameter.

7. The method according to claim 1, the method comprising receiving, from the production device, the coordination parameter.

8. The method according to claim 1, wherein coordinating the event comprises:
receiving, from the production device, a registration request for registering the event, wherein the registration request is indicative of one or more wireless devices associated with the event.

9. The method according to claim 8, wherein the registration request comprises the role parameter.

10. A method for coordinating a media session between one or more wireless devices and a production device, wherein the production device is configured to receive, from the one or more wireless devices, media data, the method comprising:
transmitting, to a network node, control signalling indicative of a coordination parameter, wherein the coordination parameter comprises a role parameter.

11. The method according to claim 10, the method comprising: assigning the network assistance requester role to the production device or to at least one of the one or more wireless devices.

12. The method according to claim 10, wherein the role parameter is indicative of an assignment of a network assistance requester role to the production device or to at least one of the one or more wireless devices.

13. The method according to claim 10, wherein the coordination parameter comprises a time parameter indicating a time period where the network node temporarily rejects a network assistance request from the one or more wireless devices.

14. The method according to claim 10, the method comprising:
transmitting, to the network node, a network assistance request; and
receiving, from the network node, network assistance information.

15. The method according to claim 10, the method comprising registering, with the network node, the event.

16. The method according to claim 10, wherein registering the event comprises:
transmitting, to the network node, a registration request for registering the event, wherein the registration request is indicative of one or more wireless devices associated with the event.

17. A method for coordinating, using a network node, a media session between the wireless device and a production device, the method comprising:
registering the wireless device to an event; and
receiving, from the network node, control signalling indicative of a coordination parameter for coordinating the media session.

18. The method according to claim 17, wherein the coordination parameter comprises a role parameter, and wherein the role parameter is indicative of an assignment of a network assistance requester role to the production device or to the wireless device.

19. (canceled)

20. The method according to claim 17, wherein the coordination parameter comprises a time parameter indicating a time period where the network node temporarily rejects a network assistance request from the wireless device, and wherein when the coordination parameter comprises the time parameter, the method comprises: not sending transmissions of a subsequent network assistance request until expiry of the time period.

21-25. (canceled)

26. A wireless device comprising a memory circuitry, a processor circuitry, and a wireless interface, wherein the wireless device is configured to perform the method of claim 17.
